(19) United States
(12) Patent Application Publication
(10) Pub. No.: US 2011/0106798 A1
(43) Pub. Date: May 5, 2011

(54) Search Result Enhancement Through Image Duplicate Detection

(75) Inventors: Yi Li, Issaquah, WA (US); Lei Zhang, Beijing (CN); Qifa Ke, Cupertino, CA (US)

(73) Assignee: MICROSOFT CORPORATION, Redmond, WA (US)

(21) Appl. No.: 12/913,430

(22) Filed: Oct. 27, 2010

Related U.S. Application Data
(63) Continuation-in-part of application No. 12/610,810, filed on Nov. 2, 2009.

(51) Int. Cl. G06F 17/30

(52) U.S. Cl. 707/728; 707/E17.014; 707/E17.017

(57) ABSTRACT

Systems, methods, and computer media for enhancing user search query results are provided. Upon receiving a user search query, relevant images are identified. Duplicate image information for the relevant images is accessed in an index. The index includes information extracted from individual images or duplicates and information aggregated according to groups comprised of images and duplicates of the images. The images identified as relevant to the user query are ranked based at least in part on the information accessed in the index.

### CROSS-REFERENCE TO RELATED APPLICATIONS

This application is a continuation-in-part of co-pending U.S. patent application Ser. No. 12/610,810, filed Nov. 2, 2009 and titled “Content-Based Image Search,” attorney docket number MFCP.152519, the disclosure of which is hereby incorporated herein in its entirety by reference.

### BACKGROUND

Internet searching has become increasingly common in recent years. Users typically enter a search keyword or phrase, and search providers return ranked search results that may include a hyperlink to a relevant web page and a text summary of the content found on the web page. Search providers may also identify images, videos, academic articles, and other types of media that are relevant to a user's keyword search query. Searching for images is becoming particularly popular.

Conventional search provider ranking mechanisms, however, do not consider actual image content when ranking search results for a user query. Images are instead typically identified and ranked for relevance based on associated text features. For a particular image, a ranking mechanism may consider keywords on the web page where the image is located, image metadata, image file name, user ratings, or other textual information. Relying solely on textual information limits the accuracy of image relevance rankings.

### SUMMARY

Embodiments of the present invention relate systems, methods, and computer media for enhancing search results through image duplicate detection. Using the methods described herein, a user search query can be received. One or more images relevant to the search query can be identified. Each image is located on a web page or domain. An index listing a plurality of images can be accessed. The index contains information relating to individual images and image groups. The index can contain an indication that one or more duplicates of the identified images are also listed in the index.

The index can also contain information extracted from each of the one or more images having duplicates also listed in the index and information extracted from the duplicates. The index can also contain, for each image having duplicates also listed in the index, aggregated information based on the total number of duplicates and based on information extracted from the image and extracted from each duplicate of the image. Duplicates of an image can include both copies of the image and near duplicates of the image, near duplicates being substantially similar to the image but altered in some way. The identified images can be ranked in order of relevance to the received user search query based at least in part on the aggregated information. A search result incorporating the ranked images can be provided.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary search result enhancement system for implementing embodiments of the present invention;

FIG. 3 is a block diagram of an exemplary duplicate processing component and index implemented in the system of FIG. 2;

FIG. 4 is a flow chart of an exemplary method for enhancing search results through image duplicate detection;

FIG. 5 is a flow chart of an exemplary method for enhancing search results through image duplicate detection in which duplicate detection is performed on demand;

FIG. 6 is a block diagram of an exemplary search result enhancement system that includes a re-ranking component; and

FIG. 7 is a flow chart of an exemplary method for enhancing search results by re-ranking the results using image duplicate detection.

### DETAILED DESCRIPTION

Embodiments of the present invention are described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention provide systems, methods, and computer media for enhancing search results through image duplicate detection. In accordance with embodiments of the present invention, search providers incorporate the presence and characteristics of duplicates of identified images in the process of relevance ranking. As discussed above, conventional search provider ranking mechanisms do not consider actual image content when ranking search results. As a result, search providers must rely on less accurate information such as associated textual clues, including keywords found on the web page where an image is located, image metadata, image file name, and user ratings, among others. Embodiments of the present invention, however, use image content to improve the accuracy of relevance ranking through duplicate detection.

The presence and characteristics of duplicates of an image can provide useful information about the image. Images found on web pages can often be easily saved, copied, and edited. Rather than linking to an image of interest located on a second web page, the provider of a first web page can simply copy and display the same image. The portability of image files results in many images having duplicates on a number of web pages or domains. The number of duplicates of a particular image can be viewed as a measure of an image's popularity or quality. For example, one high-resolution image of a famous event viewed from an advantageous angle may be copied and posted on hundreds or thousands of web pages or domains. The number of duplicates of an image can be an input into a search result ranking mechanism to improve the relevance of ranked results. Having a large number of duplicates may weigh in favor of a high relevance ranking for a given image.

“Duplicates” or “duplicate images” are copies of an image. Images may typically be downloaded from one web page and posted to another web page. Duplicates of an image may be found on the same web page as the image or on other web pages. As used in this Application, the term “duplicates” includes both duplicates and “near duplicates.” “Near duplicates” or “near-duplicate images” are images that are substantially the same but have been altered in some way, such as having been saved in a lower resolution or size, having had the color saturation adjusted, having been cropped, or having been otherwise edited. Depending upon the implementation, only duplicates, only near duplicates, or both duplicates and near duplicates of an image may be considered by a search result ranking mechanism. If a second image is identified as a duplicate of a first image, the first image is also considered a duplicate of the second image. Identification of an image on a first web page as a duplicate is not intended to identify any particular image as the “original” and does not imply that the “duplicate” image is not the “original.” Rather, identification of a duplicate can be thought of as a statement that two images are the same or substantially the same.

In addition to the number of duplicates, other information can be extracted from each image and duplicate. Extracted information may include, for example: image format; image size; image quality; an indication that the image has been edited; the web page or domain on which the image is located; and keywords associated with the web page or domain on which the image is located. The extracted information can be used as an input to a search result ranking mechanism or can be aggregated and used as a search result ranking mechanism input.

Duplicate detection can occur using a number of techniques. Content-based detection of duplicates can be performed as described in co-pending U.S. patent application Ser. No. 12/610,810, filed Nov. 2, 2009 and titled “Content-Based Image Search.” The content-based detection described in the above application involves identifying and recording points of interest.

For example, in one embodiment of the content-based image search described in the above application, an image is processed to identify points of interest. Descriptors are determined for one or more of the points of interest and are each mapped to a descriptor identifier. A search is performed via a search index using the descriptor identifiers as search elements. The search index employs an inverted index based on a flat index location space in which descriptor identifiers of a number of indexed images are stored and are separated by an end-of-document indicator between the descriptor identifiers for each indexed image. Candidate images that include at least a predetermined number of matching descriptor identifiers are identified from the indexed images. The candidate images are ranked and provided in response to the search query.

In accordance with embodiments of the present invention, a user search query is received. One or more images relevant to the search query are identified. Each identified image is located on a web page or domain. An index is accessed. The index lists a plurality of images, each image located on a web page or domain. The index may be the same as the index through which the one or more relevant images are identified. For one or more images listed in the index, the index contains an indication that one or more duplicates of the images are also listed in the index.

The index also contains information extracted from each of the one or more images having duplicates also listed in the index and information extracted from the duplicates. For each image having duplicates also listed in the index, the index contains aggregated information based on the total number of duplicates and based on information extracted from the image and extracted from each duplicate of the image. Images identified as relevant to the search query are ranked in order of relevance to the received user search query based at least in part on the aggregated information. A search result incorporating the ranked images is provided.

In another embodiment, an intake component receives a user search query. A search component identifies images relevant to the user query. An index lists a plurality of images, each image located on a web page or domain. The index may be the same index searched to identify relevant images. For one or more images listed in the index, the index contains an indication that one or more duplicates of the images are also listed in the index. The index also contains information extracted from each of the one or more images having duplicates also listed in the index and information extracted from the duplicates. For each image having duplicates also listed in the index, the index contains aggregated information based on the total number of duplicates and based on information extracted from the image and extracted from each duplicate of the image.

A duplicate processing component detects image duplicates. The processing component also extracts information from images and duplicates; aggregates extracted information and the number of duplicates detected for particular images; and stores the extracted information and the aggregated information in the index. A ranking component ranks identified images in order of relevance to the received user search query.

In still another embodiment, a user search query is received. One or more images relevant to the search query are identified, each image located on a web page. For at least one identified image, one or more duplicate images located on other web pages are detected using a content-based image search. Information is extracted from the image and duplicate images, the extracted information including one or more of: an image format, an image size, an image quality, an indication the image has been edited, the web page or domain on which the image is located, and one or more keywords associated with the web page or domain on which the image is located. At least some of the extracted information is aggregated, the aggregated information including the number of duplicate images detected. The extracted information and the aggregated information are stored in an index. The identified images are ranked in order of relevance to the received user search query based at least in part on the aggregated information stored in the index. Having a large number of duplicates weighs in favor of a high relevance ranking for a given image. A search result is provided incorporating the ranked images.

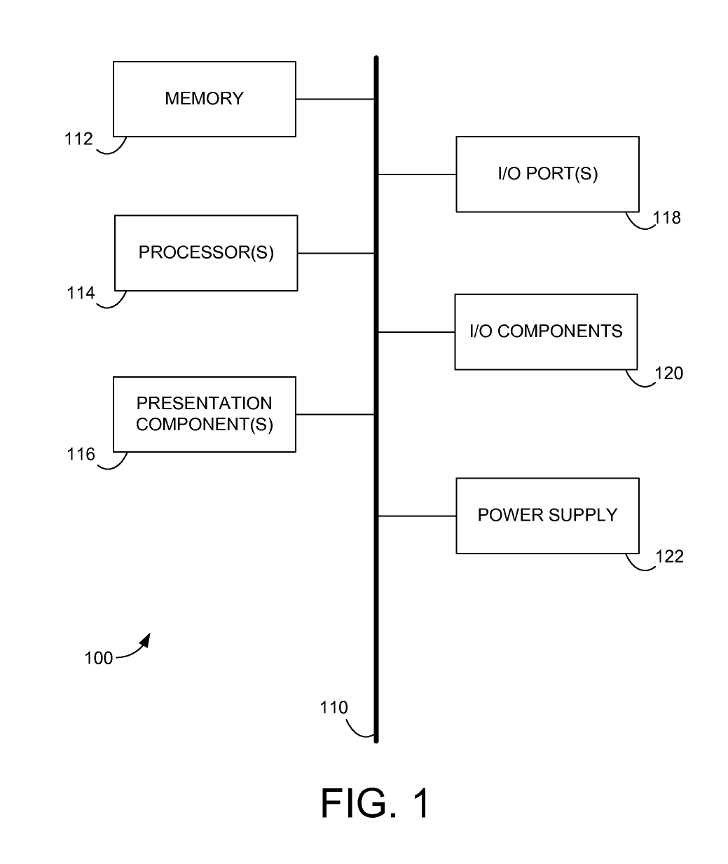

Having briefly described an overview of some embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of embodiments of the present invention. Neither should the computing device 100 be interpreted as having any dependency or requirement relating to any one or combination of components illustrated.

Embodiments of the present invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the present invention may be practiced in a variety of system configurations, including hand-held devices, consumer electronics, general-purpose computers, more specialty computing devices, etc. Embodiments of the present invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

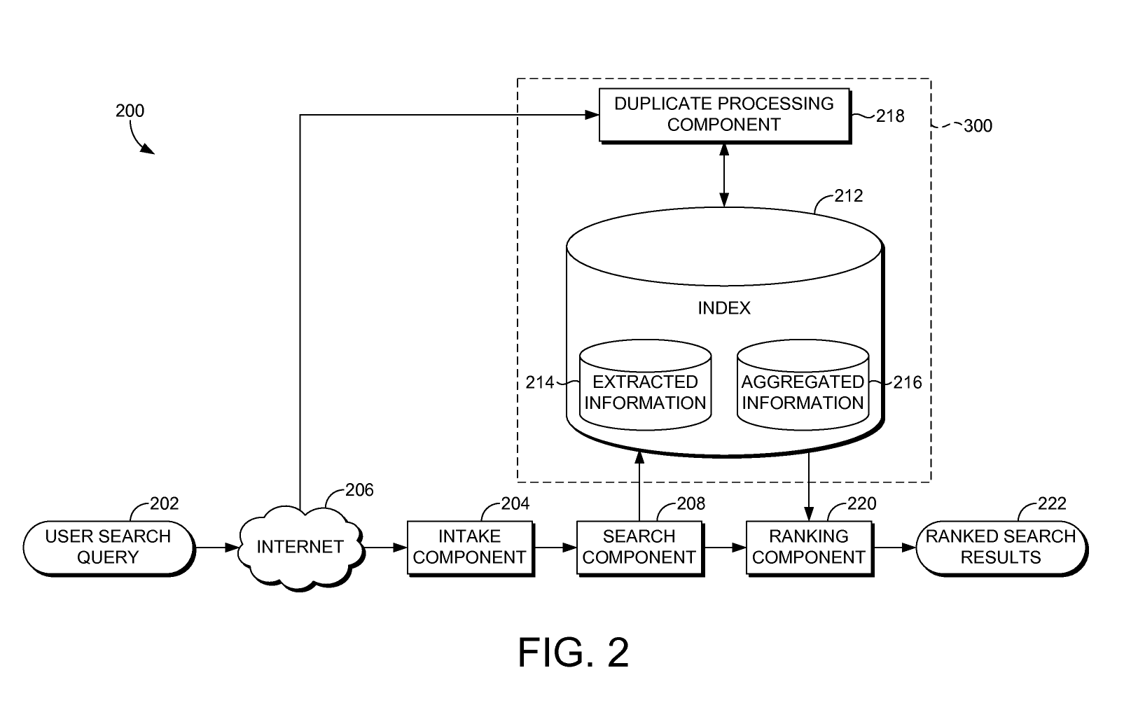

As discussed previously, embodiments of the present invention provide systems, methods and computer media for enhancing search results. Embodiments of the present invention will be discussed with reference to FIGS. 2-7.

FIG. 2 illustrates a block diagram of a system 200 for enhancing search results. A user search query 202 is entered by a user and received by intake component 204 through Internet 206. In some embodiments, user search query 202 is received via an intranet rather than through Internet 206. User search query 202 is transmitted to search component 208. Search component 208 accesses index 212 and identifies one or more images relevant to user search query 202, each identified image being located on a web page or domain listed in index 212. Index 212 may be a web index and is typically populated by crawling the web and gathering information relating to web pages and domains including keywords, tags, and links to files and other pages.

Index 212 also contains information related to image duplicates. In some embodiments image duplicate information is stored in a separate index from index 212. Both relevant images identified in index 212 and duplicate information for the identified images can then be provided to ranking component 220 for relevance ranking. Duplicate information is used as an input to ranking component 220. In some embodiments, conventional ranking inputs are also considered by ranking component 220. Index 212 contains extracted information 214 and aggregated information 216. Extracted information 214 is information extracted from each individual image or duplicate and may include, among other information, one or more of: an image format; an image size; an image quality; an indication the image has been edited; the web page or domain on which the image is located; and one or more keywords associated with the web page or domain on which the image is located. Duplicate detection and gathering of duplicate information stored in index 212 may be accomplished by performing a content-based image search on images previously identified in index 212 as a result of crawling the web. In some embodiments, duplicate detection occurs on demand as user queries are received.

Aggregated information 216 may include, among other information, one or more of: the number of duplicates detected for a particular image; the number of duplicates in a particular format, size, or quality; the number of duplicates that have been edited; and common keywords associated with the web pages or domains on which the image or duplicate is located. Aggregated information 216 is aggregated on a “group” basis such that a particular group of images and duplicates has certain characteristics or data stored in association with the group that represent the group as a whole. In some embodiments, aggregated information 216 for a particular group is associated with a group ID. The aggregated information may be stored according to the group ID. In some embodiments, each image in a group is associated with the group ID, and the aggregated information for the group is stored separately according to the group ID. In other embodiments, the aggregated information for the group is stored with each image in the group.

In some embodiments, extracted information 214, which is extracted on a per-image basis, is stored separately from aggregated information 216, which is aggregated and stored on a group ID basis. In other embodiments, information regarding the group is stored with each member of the group such that extracted information 214 and aggregated information 216 are stored together. The organization of and method of storing information in index 212 may vary according to system design and user needs.

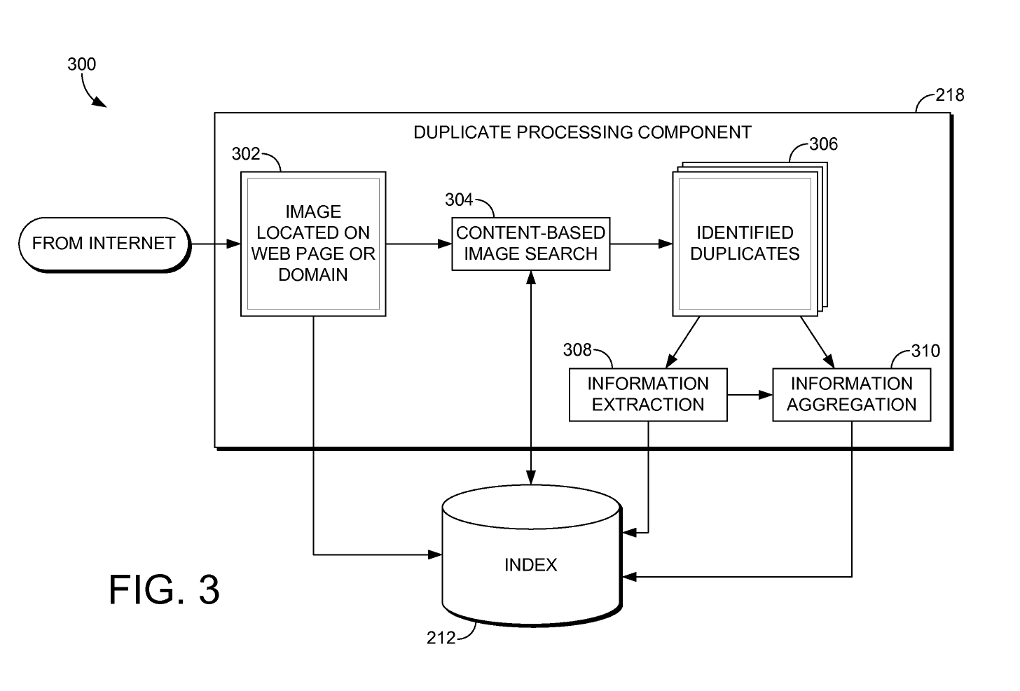

Extracted information 214 and aggregated information 216 are determined by duplicate processing component 218. The interaction between duplicate processing component 218 and index 212 is shown in more detail in FIG. 3. Returning now to FIG. 2, extracted information 214 and aggregated information 216 relating to images identified by search component 208 are provided as inputs to ranking component 220. In some embodiments, only aggregated information 216 is provided. In other embodiments, both extracted information 214 and aggregated information 216 are provided. Ranking component 220 uses the information provided by index 212 to determine or refine relevance for identified images. Ranked search results 222 are then provided.

As discussed above, the number of duplicates of a particular image can be viewed as a measure of an image's popularity or quality. In some embodiments, aggregated information 216 includes the number of duplicates of a particular image. Having a large number of duplicates may weigh in favor of a high relevance ranking for a given image. For example, if five images are identified by search component 208 as relevant to user search query 202, and one of the five images has ten times as many duplicates in duplicate image index 212 as the other four images, this relative abundance of duplicates may cause the image with more duplicates to be ranked as more relevant than the other images. While informative, the presence of duplicates is not the only input considered by ranking component 220. Consideration of other information may result in a different image being ranked most highly even if that image has fewer duplicates.

Search providers typically consider a large number and variety of factors in relevance ranking mechanisms. Although having a large number of duplicates is an indication of quality or popularity, just because an image has a large number of duplicates does not make the image necessarily more relevant than another image. Ranking component 220 may also consider other data contained in aggregated information 216 for the relevant image group, extracted information 214 from the image, and/or conventional ranking inputs. For example, the extracted information 214 for an image may indicate it is high quality, large size, or desirable format. In some embodiments, having a large number of duplicates of a high quality, large size, or desirable format may weigh in favor of a high relevance ranking for a given image. Conversely, if extracted information 214 for the image indicates it is low quality or a smaller size such as a thumbnail, this information may contribute to a lower ranking for the image. Similarly, if extracted information 214 indicates that an image has not been edited, the image may be ranked more highly than an image that has been edited. Also, having associated keywords determined to be more relevant to the user search query may weigh in favor of a high relevance ranking for a given image.

When multiple members of a group (duplicates) are identified by search component 208 in response to user query 202, additional information may be considered in determining the order in which the duplicates themselves are ranked. Consider an example in which search component 208 identifies 10 images, and it is determined by accessing index 212 that four of the ten images are duplicates and that these images also have a higher number of duplicates in index 212 than the other six identified images. The fact that the group has a large number of duplicates favors ranking each of the four images more highly. Other information, such as keywords associated with the image, image size, image quality, etc, may also be considered as ranking inputs. When the four duplicates in this example are ranked, the duplicate with highest quality or most directly related associated keywords may rank ahead of other duplicates of lower quality or less directly related keywords.

In some embodiments, the functionality of intake component 204, search component 208, and ranking component 220 may be consolidated into a single component or multiple components in a configuration other than that shown in FIG. 2. Depending on the embodiment, the various components of system 200 may or may not be in communication with the Internet 206. Further, as discussed above, in some embodiments, the information in index 212 may be divided into a web index and an image duplicate index.

FIG. 3 illustrates index 212 and duplicate processing component 218 in more detail. As discussed above, index 212 may be populated by crawling the web to identify images. Each image in index 212 can be analyzed to determine if the image has duplicates, and the results of the analysis can also be stored in index 212. In some embodiments, images are analyzed for duplicates as they are first indexed. Image 302 is identified by duplicate processing component 218. Image 302 is located on a web page or domain accessible via the Internet. A content-based image search 304 is performed on the images listed/referenced in index 212 to determine if the images in index 212 contain duplicates of image 302.

The process of analyzing an image and searching for duplicates may be performed in a variety of ways, including those identified in co-pending U.S. patent application Ser. No. 12/610,810, filed Nov. 2, 2009 and titled “Content-Based Image Search,” attorney docket number MFCP.152519, of which the present application is a continuation in-part. In some embodiments, analyzing an image includes identifying points of interest and mapping one or more points of interest to a descriptor identifier that can be used as a search element when searching an index. Duplicate images 306 are identified for image 302 via content-based image search 304. Duplicate processing component 218 can then analyze identified duplicates 306 and perform information extraction 308 for individual images and information aggregation 310 for groups of duplicates. The extracted information and aggregated information are stored in index 212.

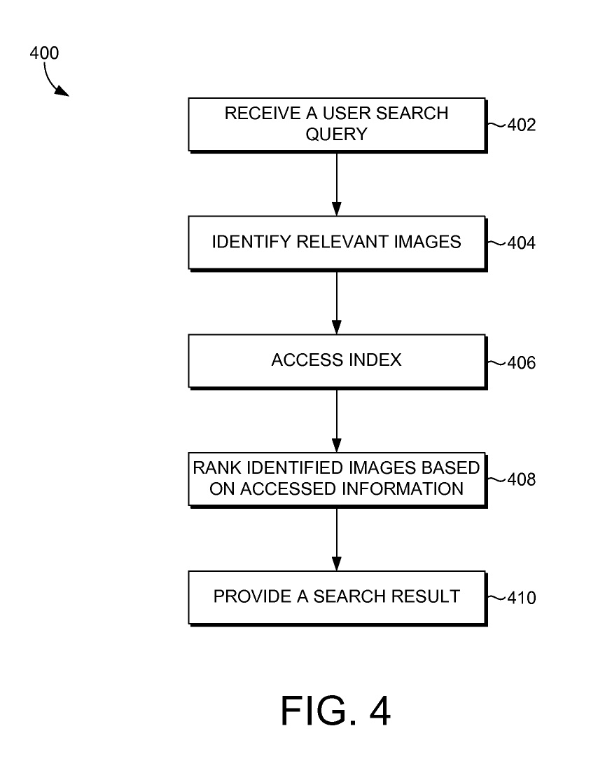

FIG. 4 illustrates an exemplary method 400 of enhancing search results. In step 402, a user receives a search query. In step 404, relevant images are identified. Step 404 may be performed according to conventional means of identifying relevant images, including searching a web index. In step 406, an index is accessed. The index accessed in step 406 may be the same index used to identify relevant images in step 404. The identified images are ranked in step 408 based at least in part on the accessed information in step 406. A search result is provided in step 410.

As discussed above, various extracted or aggregated information may be considered in the ranking performed in step 408. In one embodiment, the aggregated information includes common keywords associated with the web pages on which an image or duplicate image are located, and having associated keywords determined to be more relevant to the user search query weighs in favor of a high relevance ranking for a given image. In another embodiment, the aggregated information includes the number of duplicate images in a particular format, size, or quality, and having a large number of duplicates of a high quality, large size, or desirable format weighs in favor of a high relevance ranking for a given image.

In some embodiments, the detection of duplicate images, extraction of information, and aggregation of information is performed independently such that the information is already available when a user search query is received. In other embodiments, the analysis and detection of duplicates may be performed on demand for only the identified images.

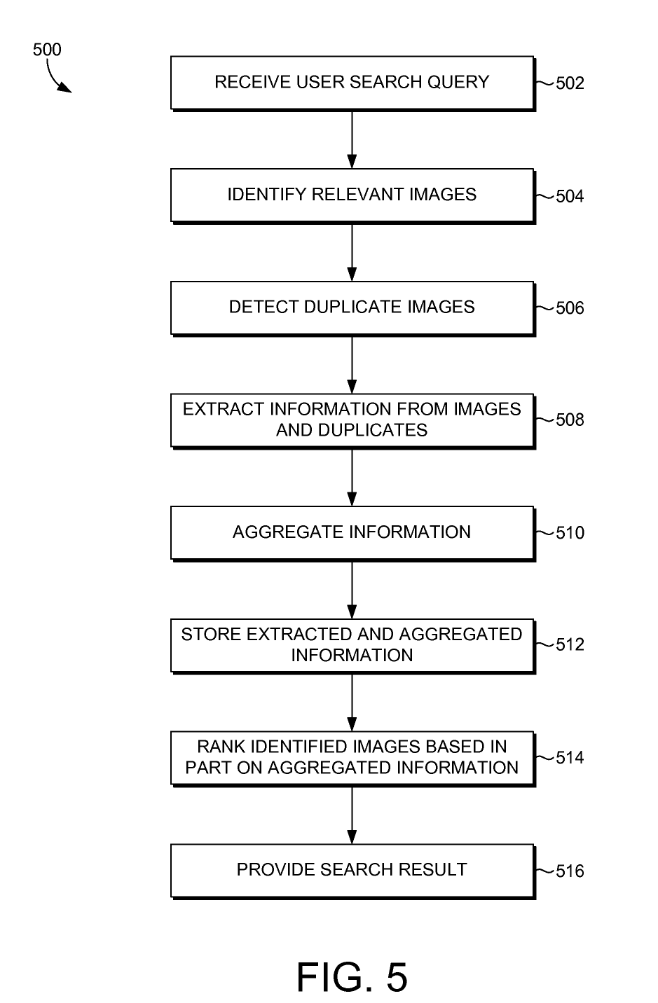

FIG. 5 illustrates a method 500 where images are identified and duplicates are searched for on demand. In step 502, a user search query is received. In step 504, relevant images are identified. Duplicate images are detected in step 506. Information is extracted from images and duplicates in step 508. Information is aggregated in step 510. Extracted and aggregated information is stored in step 512. In step 514, identified images are ranked based at least in part on the aggregated information. A search result is provided in step 516.

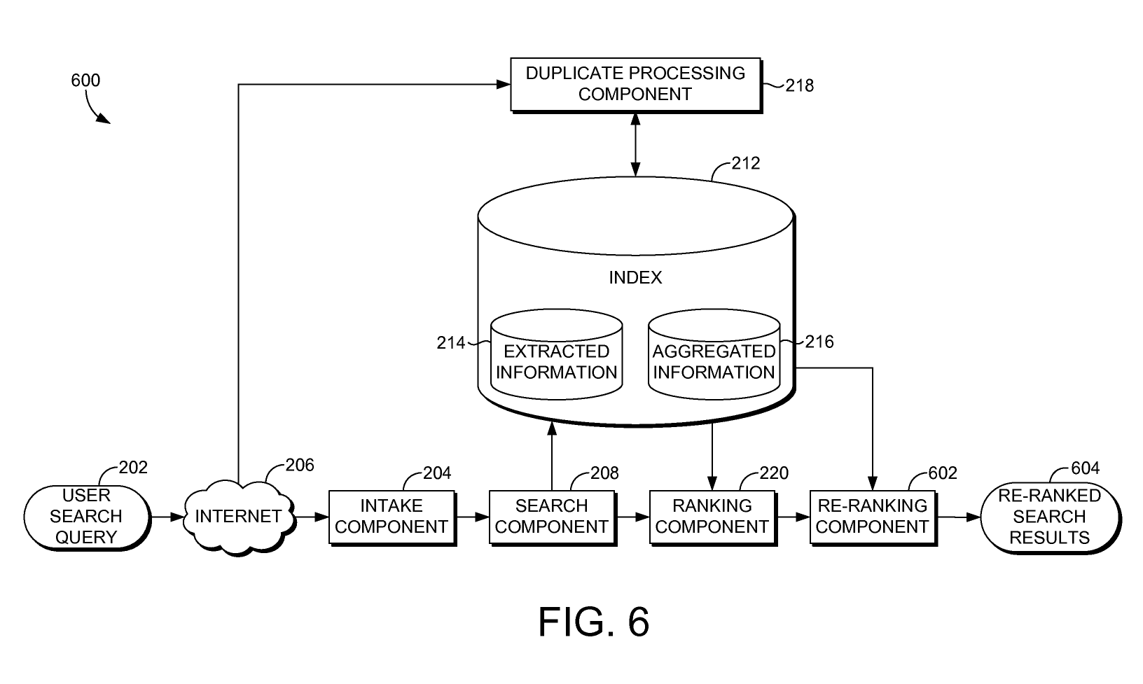

In some embodiments, image duplicate information is considered in a re-ranking process. That is, rather than considering image duplicate information as one of several factors in ranking, images are first ranked according to conventional methods and then re-ranked using the image duplicate information. FIG. 6 illustrates a system 600 including the components of the system of FIG. 2 but also including a re-ranking component 602. User search query 202 is received by intake component 204 via the Internet 206. Intake component 204 provides user search query 202 to search component 208, which identifies images in index 212 that are relevant to user search query 202. The identified images are ranked by ranking component 220. The ranking is then provided to re-ranking component 602.

Re-ranking component 602 accesses index 212, which contains extracted information 214 and aggregated information 216. The duplicate information in index 212 is determined by duplicate processing component 218. Re-ranking component 602 re-ranks the results ranked by ranking component 220 based on information accessed from index 212 to produce re-ranked search results 604. The duplicate detection process can be performed “on demand” for identified images or can be performed separately for each image in index 212 such that image duplicate information is available for each or many of the images in the index.

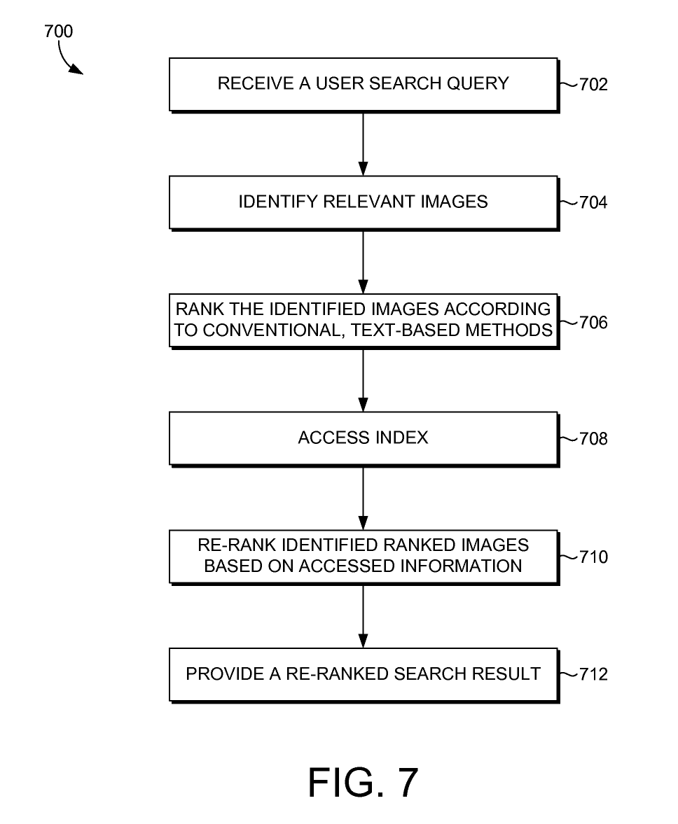

FIG. 7 illustrates a method 700 of enhancing search results in which re-ranking occurs. In step 702, a user search query is received. In step 704, relevant images are identified. The identified images are ranked according to conventional, text-based methods in step 706. In step 708, the index is accessed. The index accessed in step 708 can be the same index through which relevant images are identified in step 704. Identified images ranked in step 706 are re-ranked in step 710 based on the information accessed in step 708. A re-ranked search result is provided in step 712.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

Having thus described the invention, what is claimed is:

1. One or more computer storage media storing computer-executable instructions for performing a method for enhancing search results, the method comprising:
receiving a user search query;
identifying one or more images relevant to the search query, each image located on a web page or domain;
accessing an index listing a plurality of images, each image located on a web page or domain, the index including:
for one or more images listed in the index, an indication that one or more duplicates of the images are also listed in the index,
information extracted from each of the one or more images having duplicates also listed in the index and information extracted from the duplicates, and
for each image having duplicates also listed in the index, aggregated information based on the total number of duplicates and based on information extracted from the image and extracted from each duplicate of the image,
wherein duplicates of an image include both copies of the image and near duplicates of the image, near duplicates being substantially similar to the image but altered in some way;
ranking the identified images in order of relevance to the received user search query based at least in part on the aggregated information; and
providing a search result incorporating the ranked images.

2. The media of claim 1, wherein the ranking is based at least in part on the extracted information.

3. The media of claim 1, wherein the extracted information includes one or more of: an image format; an image size; an image quality; an indication the image has been edited; the web page or domain on which the image is located; and one or more keywords associated with the web page or domain on which the image is located.

4. The media of claim 1, wherein the aggregated information includes one or more of: the number of duplicates detected; the number of duplicates in a particular format, size, or quality; the number of duplicates that have been edited; and common keywords associated with the web pages or domains on which the image or duplicate is located.

5. The media of claim 4, wherein the aggregated information includes the number of duplicate images detected, and wherein having a large number of duplicates weighs in favor of a high relevance ranking for a given image.

6. The media of claim 4, wherein the aggregated information includes common keywords associated with the web pages on which the image or duplicate image are located, and wherein having associated keywords determined to be more relevant to the user search query weighs in favor of a high relevance ranking for a given image.

7. The media of claim 4, wherein the aggregated information includes the number of duplicate images in a particular format, size, or quality, and wherein having a large number of duplicates of a high quality, large size, or desirable format weighs in favor of a high relevance ranking for a given image.

8. The media of claim 1, wherein the one or more images identified as relevant to the search query are identified and ranked according to text features of the web pages or domains where the images are located or metadata of the images prior to accessing the duplicate image index, and wherein ranking the identified images based at least in part on the aggregated information is a re-ranking of identified images.

9. The media of claim 1, wherein the indication that one or more duplicates of the images are also listed in the index is based on a determination that an image is a duplicate of another image, the determination made using a content-based image search.

10. One or more computer storage media having a system embodied thereon including computer-executable instructions that, when executed, perform a method for enhancing search results, the system comprising:
an intake component that receives a user search query;
a search component that identifies images relevant to the user query;
an index listing a plurality of images, each image located on a web page or domain, the index including:
for one or more images listed in the index, an indication that one or more duplicates of the images are also listed in the index,
information extracted from each of the one or more images having duplicates also listed in the index and information extracted from the duplicates, and
for each image having duplicates also listed in the index, aggregated information based on the total number of duplicates and based on information extracted from the image and extracted from each duplicate of the image,
wherein duplicates of an image include both copies of the image and near duplicates of the image, near duplicates being substantially similar to the image but altered in some way;
a duplicate processing component that:
detects image duplicates,
extracts information from images and duplicates,
aggregates extracted information and the number of duplicates detected for particular images, and
stores the extracted information and the aggregated information in the index; and
a ranking component that ranks identified images in order of relevance to the received user search query.

11. The media of claim 10, further comprising a re-ranking component that re-orders ranked images based on at least one of the extracted information or the aggregated information, the ranked images ranked according to text features of the web pages or domains where the images are located or according to metadata of the images.

12. The media of claim 10, wherein the extracted information includes an image format; an image size; an image quality; an indication the image has been edited;
the web page or domain on which the image is located; and one or more keywords associated with the web page or domain on which the image is located.

13. The media of claim 10, wherein the aggregated information includes one or more of: the number of duplicate images detected; the number of duplicate images in a particular format, size, or quality; the number of duplicate images that have been edited; and common keywords associated with the web pages on which the image or duplicate images are located.

14. The media of claim 10, wherein the ranking component ranks identified images based at least in part on the aggregated information.

15. The media of claim 14, wherein the aggregated information includes the number of duplicate images detected, and wherein having a large number of duplicates weighs in favor of a high relevance ranking for a given image.

16. The media of claim 10, wherein the image duplicates are detected using a content-based image search.

17. One or more computer storage media storing computer-executable instructions for performing a method for enhancing search results, the method comprising:
receiving a user search query;
identifying one or more images relevant to the search query, each image located on a web page;
for at least one identified image:
detecting one or more duplicate images located on other web pages using a content-based image search;
extracting information from the image and duplicate images, the extracted information including one or more of: an image format, an image size, an image quality, an indication the image has been edited, the web page or domain on which the image is located, and one or more keywords associated with the web page or domain on which the image is located;
aggregating at least some of the extracted information, the aggregated information including the number of duplicate images detected; and
storing the extracted information and the aggregated information in a web index,
wherein duplicates of an image include both copies of the image and near duplicates of the image, near duplicates being substantially similar to the image but altered in some way;
ranking the identified images in order of relevance to the received user search query based at least in part on the aggregated information stored in the web index, wherein having a large number of duplicates weighs in favor of a high relevance ranking for a given image; and
providing a search result incorporating the ranked images.

18. The media of claim 17, wherein the aggregated information also includes one or more of: the number of duplicate images in a particular format, size, or quality; the number of duplicate images that have been edited; and common keywords associated with the web pages on which the image or duplicate images are located.

19. The media of claim 17, wherein the aggregated information includes common keywords associated with the web pages on which the image or duplicate images are located, and wherein having associated keywords determined to be more relevant to the user search query weighs in favor of a high relevance ranking for a given image.

20. The media of claim 17, wherein the aggregated information includes the number of duplicate images in a particular format, size, or quality, and wherein having a large number of duplicates of a high quality, large size, or desirable format weighs in favor of a high relevance ranking for a given image.
